(19) United States
(12) Patent Application Publication
(10) Pub. No.: US 2018/0097371 A1
(43) Pub. Date: Apr. 5, 2018

(54) LITHIUM BATTERY MODULE IMBALANCE RESCUE DEVICE AND WIRING ASSEMBLY THEREOF

(71) Applicant: GREAT TONE INTERNATIONAL CORP., NEW TAIPEI CITY (TW)

(72) Inventor: JAMES LIN, NEW TAIPEI CITY (TW)

(21) Appl. No.: 15/286,549

(22) Filed: Oct. 5, 2016

(51) Int. Cl. H02J 7/00; H01M 10/613; H01M 10/6563; H01M 10/44

(52) U.S. Cl. CPC H02J 7/0014; H01M 10/613; H01M 2220/20; H01M 10/441; H01M 10/6563

(57) ABSTRACT

Disclosed are a lithium battery module imbalance rescue device and a wiring assembly installed in the lithium battery module and electrically connected to each series of lithium batteries. The lithium battery module imbalance rescue device contains plural charging modules, a power input conversion module and at least one power transmission port, and the power input conversion module is provided for electrically connecting an external power source and converting an inputted power to required voltage and current to be supplied to each charging module. The wiring assembly has least one electrical connector corresponsive to the power transmission port. During use, the electrical connector is plugged into the power transmission port, so that the charging modules are respectively and electrically coupled to the strings of lithium batteries to fully charge each series of lithium batteries and prevent charging imbalance to overcome the bottleneck of conventional applications.

### FIELD OF THE INVENTION

The present invention relates to the field of lithium battery charging equipments, and more particularly to a lithium battery module imbalance rescue device and its wiring assembly capable of charging each series of lithium batteries in a lithium battery module individually to overcome the issue of battery charging imbalance caused by charging multiple strings of lithium batteries simultaneously by a conventional charging equipment.

### BACKGROUND OF THE INVENTION

### 1. Description of the Related Art

Lithium battery is a device that achieves the effect of converting chemical energy into electrical energy through the conduction of lithium ions, and the lithium ions are discharged from lithium cobalt oxide and conducted to a negative electrode through an electrolyte. During discharge, the chemical reaction takes place in a reverse direction. In general, the lithium battery is divided into lithium cobalt battery (LiCoO₂), lithium manganese battery (LiMnO₂), lithium nickel battery (LiNiO₂), lithium iron phosphate battery (LiFePO₄), etc according to the material of the positive electrode, and the material of the negative electrode primarily includes artificial graphite and modified natural graphite.

In recent years, the lithium battery with the advantages of high energy density, high power and long life changes its scope of applicability gradually from 3C products to various different electrical vehicles or hybrid vehicles to meet the environmental protection, energy saving, and carbon reduction requirements. Although traditional lead acid or nickel cadmium batteries do not have the charging/discharging problems, they have the disadvantage of heavy weight and the issue of pollution. Therefore, the research and development of the lithium battery bloom increasingly.

However, various types of chargers capable for charging lithium battery are provided for performing a total voltage charge of the lithium battery module, and the lithium battery module includes a battery management system (BMS), such that when the lithium battery is imbalanced, a good lithium battery can be fully charged to a high-voltage protection point quickly, and a circuit in the battery management system will be shut down for the purpose of protection. Even there exists a balanced resistor, the difference cannot be compensated. As a result, the imbalanced lithium battery cannot be charged fully, and the total voltage of the whole external module has reached a high point. Till the next discharge, the incompletely charged lithium battery will be discharged quickly, and the low-voltage protection of the battery management system shuts down the circuit, so that the using time becomes shorter, and this is a big problem. As this problem becomes more serious, the total capacity of the lithium battery gradually decreases, so that the driving mileage of the electrical vehicles becomes less, and it is necessary to remove the battery for repair or replacement, and such battery cannot be recovered by repeated charges. In summation, a single series of lithium batteries cannot be charged, and the aforementioned solution cannot overcome the issue of battery imbalance.

In view of the aforementioned problems of the prior art, the inventor of the present invention provides a lithium battery imbalance rescue device and its wiring assembly. With the design of the present invention, each lithium battery in the lithium battery module can be charged individually to overcome the issues of the imbalance of each series of lithium batteries in the conventional lithium battery module after a number of times of repeated discharges and a drop of capacity causing the battery unable to be fully charged.

### 2. Summary of the Invention

Therefore, it is a primary objective of the present invention to provide a lithium battery module imbalance rescue device and a wiring assembly that use a single independent circuit and an independent charging module to charge each lithium battery in the lithium battery module, so as to overcome the imbalance issue of the traditional battery charging imbalance.

Another objective of the present invention is to provide a lithium battery module imbalance rescue device and its wiring assembly with a foolproof mechanism uses an electrical connector and a power connection port or an automatic detection method to simplify the operation and improve the convenience of the operation.

To achieve the aforementioned and other objectives, the present invention provides a lithium battery module imbalance rescue device and its wiring assembly for electrically coupling the lithium battery module to adjust the charge of each series of lithium batteries of the lithium battery module, and the lithium battery module imbalance rescue device, comprises: a casing, having a containing space formed in the casing, and a plurality of through holes formed on the front side of the casing and communicated with the containing space; a plurality of charging modules, installed side by side in he containing space, and having an indication panel installed at the front side and configured to be corresponsive to the through holes; a power input conversion module, installed in the containing space, and electrically coupled to the charging modules, for electrically coupling an external power source, and supplying the required voltage and current converted by the inputted power to each charging module; and at least one power transmission port, electrically coupled to the charging modules; and the wiring assembly, respectively and electrically coupled to each series of lithium batteries of the lithium battery module, and comprising at least one electrical connector configured to be corresponsive to the power transmission port, and during use, the electrical connector is plugged into the power transmission port, such that the charging modules are respectively and electrically coupled to the strings of lithium batteries for charging.

In an embodiment of the present invention, the lithium battery module imbalance rescue device and the wiring assembly further comprise a cooling fan installed on a surface of the casing and electrically coupled to the power input conversion module for dissipating the heat accumulated in the casing, so as to extend the service life of the charging modules.

In the lithium battery module imbalance rescue device and the wiring assembly of the present invention, the power transmission port corresponds to the quantity of lithium batteries and is one selected from the group consisting a 5-pin socket, a 9-pin socket, a 13-pin socket, a 17-pin socket, and a 21-pin socket.

when the power transmission port is a 5-pin socket, the lithium battery module is configured with 4 strings of lithium batteries and a 12-volt power output; when the power transmission port is a 9-pin socket, the lithium battery module is configured with 8 strings of lithium batteries and a 24-volt power output; when the power transmission port is a 13-pin socket, the lithium battery module is configured with 12 strings of lithium batteries and a 36-volt power output; when the power transmission port is a 17-pin socket, the lithium battery module is configured with 16 strings of lithium batteries and a 48-volt power output; and when the power transmission port is a 21-pin socket, the lithium battery module is configured with 20 strings of lithium batteries and a 60-volt power output.

On the other hand, the electrical connector is configured to he corresponsive to the power transmission port, and the electrical connector is one selected from the group consisting of a 5-pin socket, a 9-pin socket, a 13-pin socket, a 17-pin socket, and a 21-pin socket. In addition, the power transmission port includes a detection unit, and when the electrical connector is plugged into the power transmission port, the detection unit automatically detect the quantity of lithium batteries corresponsive to the wiring assembly, and the charging modules of the corresponsive quantity are provided for charging.

In the lithium battery module imbalance rescue device and the wiring assembly of another embodiment of the present invention, the wiring assembly comprises a plurality of positive lines, a plurality of negative lines and a plurality of serial lines, and each positive line is coupled to a positive electrode of each series of lithium batteries, and each negative line is coupled to a negative electrode of each series of lithium batteries, and each serial line is provided for coupling the positive electrode and negative electrode of two adjacent lithium batteries, and the positive lines and the negative lines are tied into the electrical connector, and the serial lines are coupled to the positive and negative electrodes of the lithium battery module respectively. In addition, the power input conversion module steps down the voltage from 110V-220V to 3.65V-4.2V.

### BRIEF DESCRIPTION OF THE DRAWINGS

FIG. 1 is a schematic view of the structure of a preferred embodiment of the present invention;

FIG. 2 is a schematic view of installing a wiring assembly of a preferred embodiment of the present invention; and

FIG. 3 is a schematic view of a using status of a preferred embodiment of the present invention.

### DESCRIPTION OF THE PREFERRED EMBODIMENTS

The above and other objects, features and advantages of this disclosure will become apparent from the following detailed description taken with the accompanying drawings.

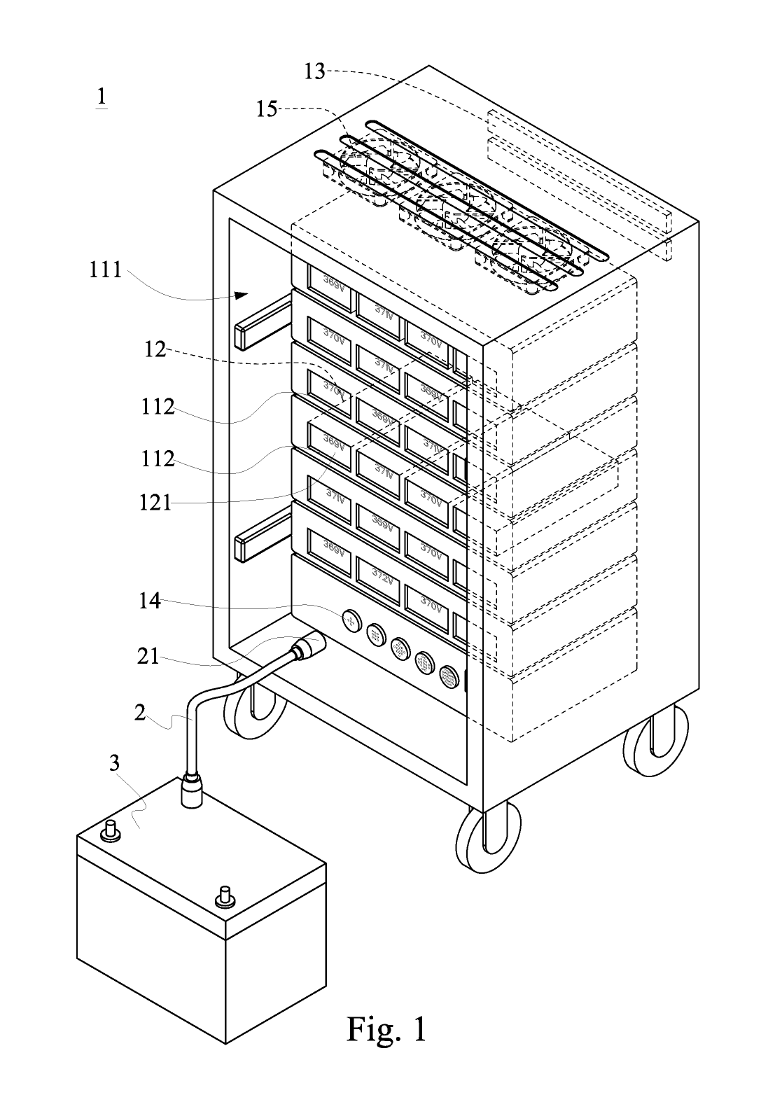

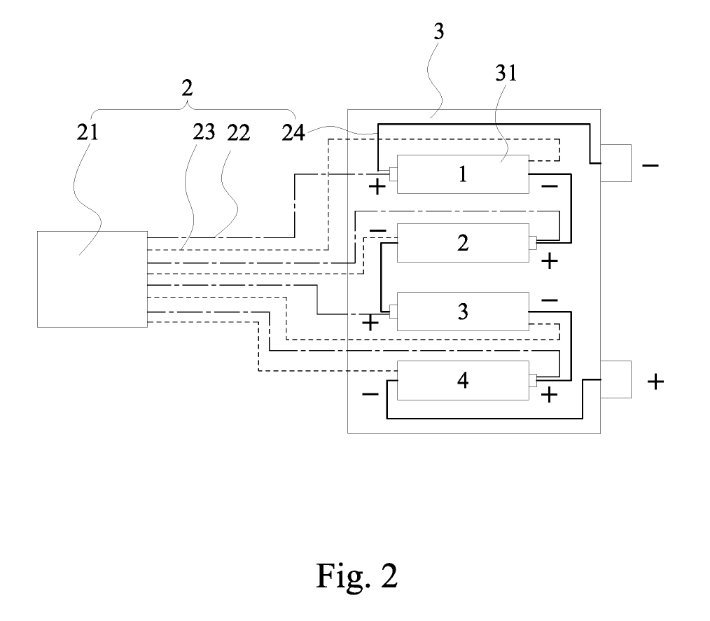

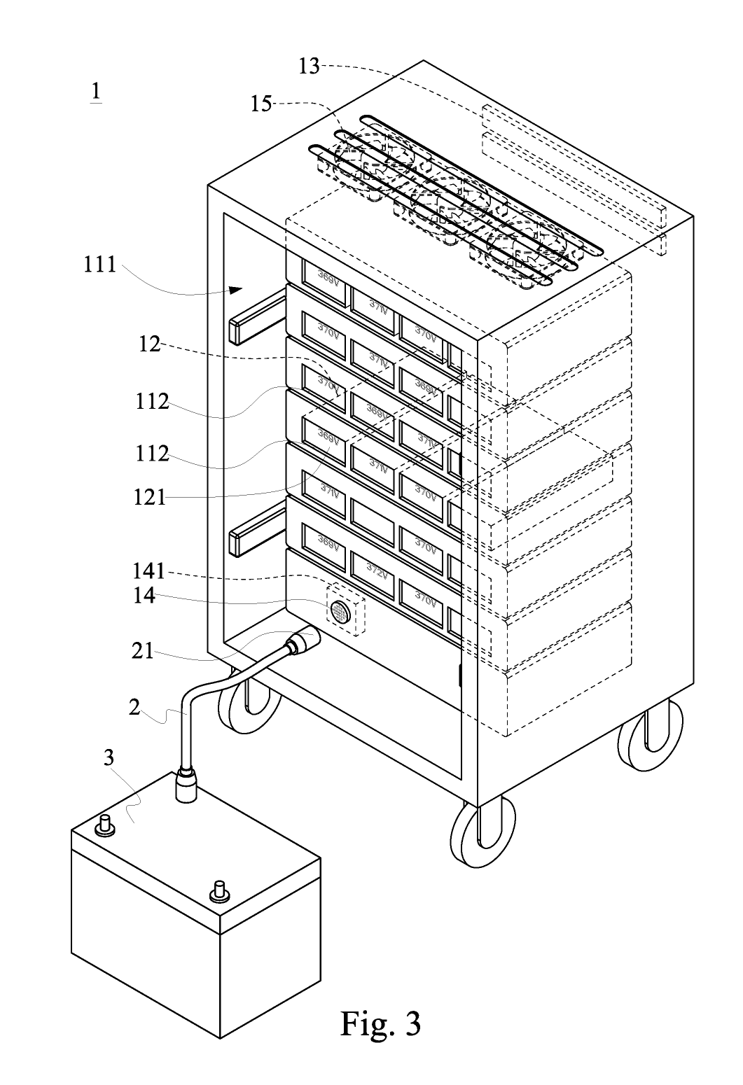

With reference to FIGS. 1 to 3 for the schematic views of the structure of a lithium battery module imbalance rescue device, a wiring assembly, and the using status of the device in accordance with a preferred embodiment of the present invention respectively, the lithium battery module imbalance rescue device 1 and the wiring assembly 2 are provided for electrically coupling the lithium battery module 3 to adjust the charging of each series of lithium batteries 31 of the lithium battery module 3.

Wherein, the lithium battery module imbalance rescue device 1 comprises: a casing 11, containing a containing space 111 formed in the casing 11, and a plurality of through holes 112 formed on a front side of the casing 11 and communicated with the containing space 111; a plurality of charging modules 12, installed side by side in the containing space 111, and having an indication panel 121 installed at the front side and configured to be corresponsive to the through holes 112. It is noteworthy that each charging module 12 comes with an over voltage protection, an over current protection and a short circuit protection, and the indication panel 121 may display a charging status such as a charging current, a charging voltage, a charging time, a capacity (in terms of %), and a remaining time for fully charging the battery during a charging process; a power input conversion module 13, installed in the containing space 111, and electrically coupled to the charging modules 12, for electrically coupling an external power source (not shown in the figure) to step down the voltage from 110V-220V to 3.65V-4.2V, and a current of 1-10 A being supplied to each charging module 12; and a plurality of power transmission ports 14, respectively and electrically coupled to the charging modules 12, and each power transmission port 14 being coupled to the charging modules 12 in a different way, so that a power transmission port 14 may be used according to a different using requirement.

The wiring assembly 2 is respectively and electrically coupled to each series of lithium batteries 31 of the lithium battery module 3, and the wiring assembly 2 has a plurality of electrical connectors 21 corresponsive to the power transmission ports 14, and the quantity of the electrical connectors 21 is equal to the quantity of the power transmission ports 14, and thus the form of the electrical connectors 21 is also corresponsive to that of the power transmission ports 14 which may be selected from a group consisting of a 5-pin socket, a 9-pin socket, a 13-pin socket, a 17-pin socket and a 21-pin socket. Before the wiring assembly 2 of the present invention is installed, a single-string independent circuit is formed to facilitate the charging, so that the wiring assembly 2 comprises a plurality of positive lines 22, a plurality of negative lines 23 and a plurality of serial lines 24, and each positive line 22 is coupled to a positive electrode of each respective series of lithium batteries 31, and each negative line 23 is coupled to a negative electrode of each respective series of lithium batteries 31, and each serial line 24 is provided for coupling the positive electrode and the negative electrode of two adjacent lithium batteries 31, and the positive lines 22 and the negative lines 23 are tied in the electrical connector 21. Specifically, each lithium battery 31 is configured to be corresponsive to a pin position of the electrical connector 21, and finally the serial lines 24 are connected to the positive and negative electrodes of the lithium battery module 3 with serial connection.

It is noteworthy that this embodiment adopts the design with a plurality of power connection ports 14, so that the power transmission ports 14 may be in a different form according to the quantity of lithium batteries 31 used in the lithium battery module 3. To apply the imbalance rescue device to the lithium battery modules 3 available in the market, the inventor of the present invention selects a combination of a 5-pin socket, a 9-pin socket, a 13-pin socket, a 17-pin socket and a 21-pin socket. If the power transmission port 14 is a 5-pin socket, the lithium battery module 3 will be configured with 4 strings of lithium batteries 31 and a 12-volt power output; if the power transmission port 14 is a 9-pin socket, the lithium battery module 3 will be configured with 8 strings of lithium batteries 31 and a 24-volt power output; if the power transmission port 14 is a 13-pin socket, the lithium battery module 3 will be configured with 12 strings of lithium batteries 31 and a 36-volt power output; if the power transmission port 14 is a 17-pin socket, the lithium battery module 3 will be configured with 16 strings of lithium batteries 31 and a 48-volt power output; if the power transmission port 14 is a 21-pin socket, the lithium battery module 3 will be configured with 20 strings of lithium batteries 31 and a 60-volt power output. During use, an operator just needs to plug the electrical connector 21 of the lithium battery module 3 into the power transmission port 14 of the corresponsive model to complete the electrical connection of the lithium batteries 31 of the lithium battery module 3 with the charging modules 12 respectively, and each charging module 12 charge each series of lithium batteries independently. Even if one of the lithium batteries 31 is imbalanced and not fully charged, the battery 31 can be recharged to an ideal condition to overcome the internal imbalance problem of the conventional lithium battery module 3.

The lithium battery module imbalance rescue device 1 of the present invention also generates heat while being used to charge the lithium batteries 31, and the generated heat is sealed in the casing 11, so that the internal components may be damaged easily after a long time of use. Therefore, a cooling fan 15 is installed on a surface of the casing 11 and electrically coupled to the power input conversion module 13 for quickly dissipating the heat accumulated in the casing 11.

The inventor of the present invention further uses a single power connection port 14 and adds a detection unit 141 electrically coupled to the imbalance rescue device, and the detection unit 141 is provided for detecting the quantity of pins of the electrical connector 21, automatically detecting the quantity of lithium batteries 31 corresponsive to the wiring assembly 2, and quickly driving a corresponsive quantity of charging modules 12 to charge the lithium batteries 31 respectively.

What is claimed is:

1. A lithium battery module imbalance rescue device and a wiring assembly thereof provided for electrically coupling the lithium battery module and adjusting the charging of each series of lithium batteries of the lithium battery module, and the lithium battery module imbalance rescue device and a wiring assembly comprising:
the lithium battery module imbalance rescue device, comprising:
a casing, having a containing space formed therein, and a plurality of through holes formed on the front side of the casing and communicating with the containing space;
a plurality of charging modules, installed side by side with each other in the containing space, and having an indication panel installed at the front side and configured to be corresponsive to the plurality of through holes;
a power input conversion module, installed in the containing space, and electrically coupled to the plurality of charging modules, for electrically coupling an external power source, and supplying the required voltage and current converted from the inputted power to each charging module; and
at least one power transmission port, electrically coupled to the charging modules; and
the wiring assembly, respectively and electrically coupled to each series of lithium batteries of the lithium battery module, and comprising at least one electrical connector configured to be corresponsive to the power transmission port, and during use, the electrical connector is plugged into the power transmission port, such that the charging modules are respectively and electrically coupled to the strings of lithium batteries for charging.

2. The lithium battery module imbalance rescue device and the wiring assembly thereof according to claim 1, further comprising a cooling fan installed on a surface of the casing and electrically coupled to the power input conversion module for dissipating the heat accumulated in the casing.

3. The lithium battery module imbalance rescue device and the wiring assembly thereof according to claim 1, wherein the power transmission port corresponds to the quantity of lithium batteries and is one selected from the group consisting a 5-pin socket, a 9-pin socket, a 13-pin socket, a 17-pin socket, and a 21-pin socket.

4. The lithium battery module imbalance rescue device and the wiring assembly thereof according to claim 3, wherein when the power transmission port is a 5-pin socket, the lithium battery module is configured with 4 strings of lithium batteries and a 12-volt power output; when the power transmission port is a 9-pin socket, the lithium battery module is configured with 8 strings of lithium batteries and a 24-volt power output; when the power transmission port is a 13-pin socket, the lithium battery module is configured with 12 strings of lithium batteries and a 36-volt power output; when the power transmission port is a 17-pin socket, the lithium battery module is configured with 16 strings of lithium batteries and a 48-volt power output; and when the power transmission port is a 21-pin socket, the lithium battery module is configured with 20 strings of lithium batteries and a 60-volt power output.

5. The lithium battery module imbalance rescue device and the wiring assembly thereof according to claim 4, wherein the electrical connector is configured to be corresponsive to the power transmission port, and the electrical connector is one selected from the group consisting of a 5-pin socket, a 9-pin socket, a 13-pin socket, a 17-pin socket, and a 21-pin socket.

6. The lithium battery module imbalance rescue device and the wiring assembly thereof according to claim 5, wherein the power transmission port includes a detection unit, and when the electrical connector is plugged into the power transmission port, the detection unit automatically detect a quantity of lithium batteries corresponsive to the wiring assembly, and the charging modules of a corresponsive quantity are provided for charging.

7. The lithium battery module imbalance rescue device and the wiring assembly thereof according to claim 1, wherein the wiring assembly comprises a plurality of positive lines, a plurality of negative lines and a plurality of serial lines, and each of the plurality of positive line is coupled to a positive electrode of each of the series of lithium batteries, and each of the plurality of negative line is coupled to a negative electrode of each of the series of lithium batteries, and each of the plurality of serial line is provided for coupling the positive electrode and negative electrode of two adjacent lithium batteries, and the positive lines and the negative lines are tied into the electrical connector, and the serial lines are coupled to the positive and negative electrodes of the lithium battery module respectively.

8. The lithium battery module imbalance rescue device and the wiring assembly thereof according to claim 1, wherein the power input conversion module steps down the voltage from 110V-220V to 3.65V-4.2V.
